(19) United States
(12) Patent Application Publication
(10) Pub. No.: US 2004/0211222 A1
(43) Pub. Date: Oct. 28, 2004

(54) Metal die for forming optical element

(75) Inventor: Shigeru Hosoe, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION.

(21) Appl. No.: 10/295,960

(22) Filed: Nov. 18, 2002

(30) Foreign Application Priority Data
Nov. 21, 2001 (JP) 356647/2001

(51) Int. Cl. C03B 11/08

(52) U.S. Cl. 65/374.12

(57) ABSTRACT

A optical element forming die has a die base body; and an optical surface transferring layer to form an optical surface of the optical element, the optical surface transferring layer formed by depositing an amorphous alloy having a supercooled liquid region on the die base body, wherein a plurality of projections or concavities are provided on the optical surface transferring layer so that a plurality of concavities or projections corresponding to the plurality of projections or concavities on the optical surface transferring layer are transferred and formed on the optical surface of the optical element.

### BACKGROUND OF THE INVENTION

This invention relates to a metal die for molding an optical element which are formed by the use of an amorphous alloy having a supercooled liquid region, and to an optical element formed by the metal die for molding optical elements.

According to a method of making a metal die for molding plastic optical elements which has heretofore been practiced in general, an optical surface transfer surface for molding the optical surface of an optical element has been obtained through the following steps: making a blank (a primary worked article) of a steel material or a stainless steel material for example, plating an amorphous nickel-phosphorous alloy to a thickness of 100 μm on the blank by chemical plating called electroless nickel plating, and cut-working this plating layer by a super-precision machine tool with a diamond tool.

According to such a conventional technological method, because the shape of parts are basically generated by mechanical working, the precision of the parts can be easily enhanced nearly to the precision of the motion of the machine tool; however, on the other hand, the following failures have been produced: that mechanical working and plating processing are mixedly present in the production process which makes the process troublesome and makes the delivery time long, that it is necessary to produce a blank (a primary worked article) with the thickness of the plating layer taken into consideration, that the plating processing is not always stable, the adhesion strength of the plating layer disperses owing to the deviation of the composition and the degree of smudging of the blank, and pinhole-shaped defects called pits are produced, and that because the optical surface transfer surface must be generated within the depth of the plating layer, when the optical surface transfer surface is reworked for example, the plating layer has no margin in its thickness which makes working impossible in some cases.

Further, according to a conventional technology, it is necessary to cut-work optical surface transfer surfaces with a diamond tool in large quantities, and in this case, there is also a problem that, subjected to the influence of the condition of the cutting edge of the tool, the working conditions, the change of the working environment temperature, etc., the shape of the optical surface transfer surfaces delicately disperses. This dispersion in the optical surface transfer surfaces by working is resulted from the inferiority of the machinability of the raw material; generally speaking, a shape error of the optical surface of an order of 100 nm is produced, and even in the case where working is done very prudently, a shape error of about 50 nm remains; this makes a precision limit of the working in creating optical surface transfer surfaces of the same shape in large quantities.

Further, in recent years, an optical element which can efficiently correct color aberration by being provided with ring-shaped diffractive grooves (diffractive ring-shaped zones) on its optical surface is put into practical use in the field of optical information recording etc., and a mass of the optical elements are produced. For the optical material, plastic and glass are used, and for an infrared optical system etc., a crystal material such as ZnSe crystal is also used. Such optical elements can be produced in large quantities and efficiently, and it is an extremely important subject how to produce the microscopic diffractive grooves in the optical surface of the optical elements with a metal die for molding an optical element at a high accuracy and efficiency in molding them.

For example, in the case where a microscopic pattern having an optical function such as diffractive grooves is generated on the optical surface transfer surface of a metal die for molding an optical element by diamond cutting, the sharpness of the edge corner predominates the preciseness of the shape of the diffractive grooves, and it influences the diffraction efficiency greatly when the surface shape is transferred to the optical surface of an optical element.

Hence, in order not to lower the diffraction efficiency of the diffractive ring-shaped zones, it is necessary to make small enough the size of the cutting edge corner, and if it is done, cutting resistance is concentrated on the small cutting edge corner portion which makes it necessary to make the cutting amount smaller, and as the result, the number of times of working increases until the whole optical surface is uniformly cut to become the target shape. Further, also for the purpose of preventing the degradation of the surface roughness of the optical surface due to the small cutter marks of the cutting edge corner, the feed rate of the tool should be lowered, which makes longer the working time of the optical surface transfer surface for one time. As the result of it, in the cut-working of a metal die for molding an optical element having diffractive grooves, the wear of the cutting edge of the tool becomes remarkable owing to the increase of cutting length, which makes the replacement of the tool frequent. That is, in the case where an optical surface transfer surface having a microscopic pattern is worked by conventional diamond cutting, the life of the tool becomes extremely short, and on top of it, the time for working one optical surface transfer surface also becomes longer, which makes it necessary to replace the tool frequently; therefore, working efficiency is very much lowered and the productivity of the metal die for molding an optical element is also lowered, which brings about a sharp increase of the cost. For that reason, particularly in the case where an optical surface transfer surface having a microscopic pattern on it is finished by diamond cutting, it is desired a method of producing a metal die which does not include an electroless plating process, is simple, and has a short delivery time.

In addition to the above-mentioned, in recent years, it has been tried to add a new optical function to an optical element by the application of a microscopic structure having a size of several times of the wavelength of the light used or smaller than it. For example, it has been put into practical use in a pickup objective lens for an optical disk with interchangeable use of a DVD and a CD, to give a usual light converging function based on the refraction action of a molded lens and an achromatizing function, which cannot be obtained originally by the refracting function only, obtained by canceling the positive dispersion generated as a side effect in the light converging by the utilization of a large negative dispersion owing to the diffraction obtained by the formation of diffractive grooves on the aspherical optical surface of the lens. This is a lens which utilizes a refractive action by diffractive grooves having a size of several tens times the wavelength of the light passing the optical element, and a region where a diffractive action by a structure having a size sufficiently larger than the wavelength is handled is called a scalar region.

On the other hand, it is proved that a function of suppressing light reflection can be exhibited by the formation of cone-shaped projections at microscopic intervals of a fraction of the wavelength of the light passing an optical element in close concentration on the optical surface. That is, it is possible to suppress light reflection when a light wave enters an optical element by a gentle variation of refractive index at the border surface between the optical element and the air by cone-shaped projections arrayed at microscopic intervals, not by the sharp change of refractive index from 1 to that of the medium as is observed in a conventional optical element. An optical surface having such projections formed on it has a microscopic structure what is called moth eyes, which functions against a light wave as an averaged refractive index by microscopic structural members smaller than the wavelength of the light being arrayed at equal intervals shorter than the wavelength with each structural member not diffracting light any more. Such a region is generally called an equivalent refractive index region. As regards such an equivalent refractive index region, for example, it is described in “Journal of the Institute of Electronics, Information and Communication Engineers C, Vol. J83-C, No. 3, pp. 173-181, March, 2000”.

By a microscopic structure in an equivalent refractive index region, compared to a conventional reflection reducing coating, a larger reflection reducing effect can be obtained with the angle dependence and wavelength dependence of the reflection reducing effect made smaller; further, by plastic molding etc., because an optical surface and a microscopic structure can be generated at the same time, a lens function and a reflection reducing function can be obtained at the same time, which is regarded as an effect enhancing the merit in production such that no after-processing like the formation of a reflection reducing coating is required for example, and it is very much remarked. Further, if such a microscopic structure in an equivalent refractive index region is arranged in such a way as to have a directivity against the optical surface, it is also possible to make the optical surface have a strong optical anisotropy, which makes it possible to obtain a birefringence optical element by molding which has heretofore been produced by cutting out a crystal such as a quartz crystal, and further, a new optical function can be added by combining it with a refraction or reflection optical element. The optical anisotropy in this case is called a structural birefringence.

Between the above-mentioned scalar region and equivalent refractive index region, there is a resonance region where refraction efficiency is sharply varied due to a slight difference of incidence condition. For example, if the groove width of diffractive ring-shaped zones is made smaller, it occurs a phenomenon (anomaly) that refraction efficiency suddenly decreases at about several times of the wavelength and again it increases. By the utilization of this characteristic of the region, a wave guide mode resonance lattice filter which reflects a light wave having a particular wavelength only is actualized with a microscopic structure, and an effect equivalent to that of a usual interference filter can be actualized with the angle dependence decreased.

Incidentally, in the case where an optical element is formed by the utilization of the scalar region, equivalent refractive index region, or resonance region, it is necessary to form microscopic projections (or concavities) on its optical surface. For the mass production of optical elements provided with such microscopic projections (or concavities), generally speaking, it can be said that it is appropriate to carry out the molding with a plastic material used as a raw material; however, in this case, it is necessary to provide in a metal die for molding an optical element, an optical surface transfer surface having concavities (or projections) corresponding to the microscopic projections (or concavities).

As regards the projections (or concavities) in an equivalent refractive index region or resonance region as described in the above, however, it is necessary to form the projections (or concavities) at intervals of several tens or several hundreds of nanometers, and it is extremely difficult to do it by mechanical working including cut-working.

### SUMMARY OF THE INVENTION

This invention has been made in view of the above-mentioned points of problem of the conventional technology, and it is its object to provide a metal die which is excellent in machinability and whose accuracy of dimensions can be enhanced with all its low cost and ease of handling, and an optical element molded by the metal die.

### BRIEF DESCRIPTION OF THE DRAWINGS

FIGS. 1(a) to 1(e) are drawings showing a production process of a master die for producing a metal die for molding an optical element;

FIG. 2 is a drawing showing a production process of a metal die for molding an optical element;

FIGS. 3(a) to 3(c) are drawings showing a production process of a metal die for molding an optical element;

FIG. 4 is a cross-sectional view of a die set containing a metal die for molding an optical element for forming a lens as an optical element;

FIGS. 5(a) to 5(d) are perspective views each showing enlarged the optical surface of a lens formed by a metal die for molding an optical element; and

FIG. 6 is a cross-sectional view of a fixture for pattern transfer which was used in a test practiced by the inventors of this invention.

### DETAILED DESCRIPTION OF THE PREFERRED EMBODIMENT

First, a desirable structure of this invention will be explained.

A metal die for molding an optical element as set forth in the paragraph 1 is a metal die for molding an optical element formed by depositing an amorphous alloy having a supercooled liquid region on a base member, and forming an optical surface transfer surface for molding the optical surface of an optical element in said amorphous alloy, characterized by it that, in order that a plurality of projections or concavities may be formed by transfer on the optical surface of an optical element to be molded by said metal die for molding an optical element, corresponding concavities or protrusions are formed on said optical surface transfer surface.

Prior to this invention, in an example of practice described concretely as an example of the embodiment of the invention described in the description of the patent applications 2001-054182 and 2001-054183, it is proposed by the inventors of this invention, a method for making a metal die for molding an optical element by mold-transferring a microscopic structure of a parent die to the optical surface transfer surface of said metal die through press-molding a heat-softened bulk material of amorphous alloy having a supercooled liquid region. This method of producing a metal die for molding an optical element using a bulk material has an efficiency remarkably better than a conventional method in which an optical surface transfer surface is generated by the application of a mechanical working only to a chemical plating material, and on top of it, it has an excellent characteristic that an optical surface transfer surface having a microscopic structure, which is difficult to form by conventional mechanical working, can be generated in large quantities, at a high precision, and at a low cost. Further, even if a comparatively high-priced material is used, by heating and melting the used metal die again and rapidly cooling it, recycling is possible any number of times; therefore, the material can be utilized semi-eternally, and as the result of it, the material cost can be reduced remarkably. Because the amorphous alloy having a supercooled liquid region, however, has a characteristic different from a steel material which is a material for a usual metal die, there is a problem to be paid regard to in the handling of it. Therefore, this invention as set forth in the paragraph 1 is one that makes it possible to generate a more excellent metal die for molding an optical element by which a high-precision optical element can be produced in a large quantities at a low cost without spoiling the advantage in the case of using it as a material of a metal die for molding an optical element, with the characteristic of an amorphous alloy having a supercooled liquid region taken into consideration.

Now, amorphous alloy (non-crystallized alloy) having a supercooled liquid region, what is called metallic glass will be explained. This is material composed of amorphous alloy material which becomes supercooled liquid by heating; in contrast to usual metal having a polycrystalline structure, owing to the structure being amorphous, it has such characteristics which are not to be observed in usual metals, that it has a microscopically uniform composition, is excellent in mechanical strength and chemical resistivity at the normal temperature, has a glass transition temperature, and when heated to a temperature falling within a range of the glass transition temperature to the crystallization temperature (usually, this is about the glass transition temperature+200° C.) which is the supercooled liquid region, it becomes softened in a vitreous state to become capable of working by press molding. Further, it has been discovered by the inventors of this invention that, also in cut-working, in particular, when it underwent a super-precision cut-working with a diamond tool, a high-accuracy mirror surface could be easily obtained. The reason is construed as follows: because this material is amorphous and has no crystal boundary, the machinability is not dependent on the position in it and uniform; further, because it is made a polycrystalline substance in a compositional way by making the crystallization energy large in order to maintain the amorphous state, less diffusion and wear of the diamond tip during cut-working is produced which makes it possible to keep the life of the tool edge longer. For a bulk material which can be practically used in generating an optical surface transfer surface by super-precision cut-working, only soft metals have heretofore been known, and although material having a high hardness such as silicon or glass could undergo cut-working in a ductility mode based on a very small cutting depth (around 100 nm) only, it was extremely of low efficiency. Hence, it can be said that to use an amorphous alloy as a material of a metal die was a discovery suggesting an extremely great development of application in the working for generating an optical surface as centered on metal dies. A similar working characteristic appears also in grind-working using a diamond grinding wheel or the like in such a way that the grinding ratio can be made large, for example.

The technology which was disclosed in the prior applications was one that makes it possible, compared to a conventional method of generating a metal die for molding an optical element based on electroless nickel plating, to obtain a metal die for molding an optical element at a remarkably high efficiency and accuracy, and at a low cost; however, it raised following problems at the same time.

A metal die for molding an optical element using a bulk material of metallic glass has the defect resulting from the material being amorphous that when an external force is applied to it, the stress is not relaxed and it produces a breakage, in other words, it is easily broken. Owing to this defect, for example, in the case where a metal die part using a metallic glass is tapped for fixing, after the base hole is cut-worked with a drill or the like, when a tap is driven into the hole, a large cutting stress acts due to the deep cutting amount, which produces a possibility to break the metal die part from the tapped portion as the starting point. In order to prevent this, it is necessary some device such that when the bulk material is worked by heat press molding, a part made of metal is inserted at the tapping portion and molded. Further, in actually molding an optical element using a plastic material or the like with such a metal die for molding an optical element mounted in a die set, in the case where the die tightening force is received directly by this metal die, or in the case where a torsion force resulting from a sliding motion inside the die set acts, there is a possibility of the metal die for molding an optical element being broken during the formation of an optical element. Further, as regards the outer peripheral portion and the sliding portion of a metal die for molding an optical element, cut-working based on a deeper cutting amount becomes frequently necessary than its optical surface transfer surface, and in finishing the outer peripheral portion and the sliding portion of a metal die for molding an optical element by cut-working using a versatile machine tool before or after the formation of the metal die, if the metallic glass is worked with a too deeper cutting amount applied to it, because the temperature at the cutting portion easily exceeds the glass transition temperature Tg of the material, a phenomenon such that a viscous fluid is dragged by the edge corner occurs, and a large cutting force acts momentarily to possibly raise a problem of breakage being produced from this point as the starting point. In this way, although a metallic glass has very excellent characteristics as a metal die material such as a high machinability, a good workability by heat press molding, and a high hardness, owing to its uniform composition, it has the disadvantage that it is breakable. Further, as regards a Vanadium-contained metallic glass for example, it is easily formed by heat press molding in an atmospheric environment by taking the advantage of its having a noble metal as the main constituent; on the other hand, there is a problem that because it has a high raw metal value as a die part, it is necessary to perform the safekeeping management strictly, and it is inferior in the ease of handling to a steel material etc.

In this way, in a method in which the desired optical surface transfer surface or/and geometrical dimension reference surface transfer surface is generated by the diamond cut-working or heat press molding of a bulk material of metallic glass, and a metal die for molding an optical element is obtained, it can be said that there is somewhat a room for improvement practically in actually molding an optical element.

This invention, in view of the problems concerning the method of generating a metal die for molding an optical element using a bulk material of metallic glass as well as a metal die for molding an optical element based on a conventional technology, is resulted from the attempt to solve the problems extremely effectively. For example, by depositing a film of amorphous alloy having a supercooled liquid region on a base member formed of a steel material having toughness or the like, and forming an optical surface transfer surface and/or a geometrical dimension reference surface transfer surface for forming a geometrical dimension reference surface of an optical element, in the case where the above-mentioned optical surface transfer surface and/or a geometrical dimension reference surface transfer surface is formed by cut-working using a diamond tool or the like, owing to the cut portion being a film of the above-mentioned amorphous alloy, its machinability is secured good, and the life of the tool is made longer; therefore, compared to an electroless nickel plating method, a metal die for molding an optical element can be obtained at a high accuracy and high efficiency, and at a low cost. Further, in the case where the above-mentioned optical surface transfer surface and/or a geometrical dimension reference surface transfer surface is formed by heat press molding, owing to the portion to be formed by heat press molding being a film of said amorphous alloy, it is excellent in machinability, and on top of it, because it is sufficient to heat the above-mentioned amorphous alloy portion and its neighboring portion only, a heater having only a small capacity is good enough for the heating, and it can be performed rapidly; therefore, working of high efficiency becomes possible. On the other hand, in the case where tap-working is applied to the above-mentioned metal die for molding an optical element, by drilling a hole and tapping for said base member, the breakage etc. of said metal die for molding an optical element can be suppressed. Further, after it is mounted in a die set, against an external force generated at the time of molding, concentration of stress can be relaxed owing to the advantage of said base member being tough, which makes it possible to prevent breakage. In addition, it is of no concern whether the optical surface transfer surface is generated by cut-working or generated by heat press molding. Further, in the case where a geometric dimension reference surface is provided in an optical element, it is desirable to deposit a metallic glass material, that is, an amorphous alloy material having a supercooled liquid region, also onto the portion of the base member of the metal die for molding an optical element corresponding to the portion where a geometrical dimension reference surface transfer surface for forming its geometrical dimension reference surface in the same way as the optical surface transfer surface for an optical element, to apply various kinds of surface treatment or surface working process. In the above, a geometrical dimension reference surface of an optical element means a surface which becomes the reference for the determination of its location when the optical element is fitted to some other member, just like the ring-shaped surface area of the flange portion of the optical element.

In addition to the above, by this invention, in the case where it is necessary that, in order to form by transfer a plurality of projections or concavities on an optical element to be formed by the above-mentioned metal die for molding an optical element, corresponding concavities or projections are formed on the above-mentioned optical surface transfer surface, even if the projections or concavities must be arrayed at intervals of several tens or several hundreds of nanometers, they can be easily formed by transfer molding without the necessity of mechanical working. In addition, the term “concavities or projections” includes those which are composed of both concavities and projections mixedly.

The inventors of this invention thought of it that, by optimizing the molding pressure and the molding time, transfer-forming could be performed for an amorphous alloy, with a better reproducibility, at an accuracy the same as or higher than an optical surface to be obtained by plastic molding, because the points in which the molding of an amorphous alloy is basically different from that of a plastic material can be noted as follows: its thermal conductivity is very high owing to its being a metallic material, which makes the whole body instantaneously be solidified, cooling contraction is small and generated proportionally independently of the molding portion, and reactivity to the die is low.

Further, the inventors thought that, as regards a metal die for molding an optical element having microscopic projections or concavities on the optical surface transfer surface, if a metal die for molding an optical element made of the above-mentioned amorphous alloy was obtained by transfer molding from some master die, it could be actualized to obtain metal dies for molding an optical element easily in large quantities, which should have a higher accuracy of shape than an optical element made of plastic or the like which is the final product.

That is, if there is one master die having a high accuracy of shape, metal dies for molding an optical element of this invention can be produced easily in large quantities. As regards the formation of such a master die, further, for example, it can be thought of a method in which a surface corresponding to the optical surface of an optical element (generating optical surface) is coated with a resist material by a spin coating method or the like, and after it is exposed to an electron beam or a laser beam in a microscopic pattern, the microscopic pattern drawn on the generating optical surface is made a pattern of the resist material. By this method, it is possible to form microscopic projections (or concavities) which are extremely difficult to generate by a usual method of generation based on mechanical working.

Any kind of amorphous alloy can be used for a metal die for molding an optical element of this invention. Any metallic glass known to the public of Pd-alloy, Mg-alloy, Ti-alloy, Fe-alloy, Zr-alloy, etc. can be used; it is an essential factor for this invention that the alloy is an amorphous alloy having supercooled liquid region, and it is unnecessary to pay regard to the composition and kind of these alloys. In addition, as a metal die material for molding a plastic optical element, because the resin temperature becomes near to 300° C., a Pd-alloy, a Ti-alloy, an Fe-alloy, etc. are advantageous owing to the glass transition temperature being high, and more desirably, a Pd-alloy is advantageous also in the point that it is hardly oxidized in air and can be worked by heat pressing. In this case, although Pd (palladium) is a noble metal and high-priced, as regards a metal die for molding an optical element of this invention, it is possible to form a different pattern again by heating said deposited amorphous alloy as occasion demands.

A metal die for molding an optical element as set forth in the paragraph 2 is such one that projections or concavities of the optical surface of said optical element form a microscopic structure in the equivalent refractive index region; therefore, it is possible to enhance the light transmittance of said optical element. Besides, it is desirable that the interval of said projections or concavities is not greater than the wavelength of a light wave passing the optical surface of said optical element.

A metal die for molding an optical element as set forth in the paragraph 3 is such one that projections or concavities of the optical surface of said optical element form a microscopic structure exhibiting reflection reducing effect; therefore, it is possible to enhance the light transmittance of said optical element. Besides, it is desirable that the interval of said projections or concavities is not greater than the wavelength of a light wave passing the optical surface of said optical element.

A metal die for molding an optical element as set forth in the paragraph 4 is such one that projections or concavities of the optical surface of said optical element form a microscopic structure generating structural birefringence; therefore, it is possible to vary the light transmittance of said optical element in accordance with the direction of oscillation of the light wave. Besides, it is desirable that the interval of said projections or concavities is not greater than the wavelength of a light wave passing the optical surface of said optical element.

A metal die for molding an optical element as set forth in the paragraph 5 is such one that projections or concavities of the optical surface of said optical element form a microscopic structure in the resonance region; therefore, it is possible to exhibit different functions by varying the degree of the aberration of said optical element, for example.

A metal die for molding an optical element as set forth in the paragraph 6 is such one that projections or concavities of the optical surface of said optical element have a function to adjust the change of aberration due to the change of the wavelength of the light wave from the light source for irradiating said optical element; therefore, it is possible to enhance higher the function of said optical element.

A metal die for molding an optical element as set forth in the paragraph 7 is such one that projections or concavities of the optical surface of said optical element have a function to adjust the change of aberration due to temperature variation; therefore, it is possible to enhance higher the function of said optical element.

A metal die for molding an optical element as set forth in the paragraph 8 is such one that projections or concavities of the optical surface of said optical element are diffractive ring-shaped zones; therefore it is possible to make unnecessary or simpler the cut-working which has heretofore been carried out for forming the shape corresponding to the diffractive ring-shaped zones on the aforesaid optical surface transfer surface; thus, it is possible to reduce the cost and labor required for the working.

A metal die for molding an optical element as set forth in the paragraph 9 is characterized by it that projections or concavities of the optical surface of said optical element are present in a part of said optical surface, and in a part of the aforesaid optical surface transfer surface, there are present corresponding concavities or projections in order that the optical surface may be formed by transfer.

For example, by arranging projections or concavities provided on the optical surface of an optical element not uniformly on the whole surface of the optical surface but in a part of it, it is possible to make the optical surface exhibit a partial or selective optical function such that, as regards a bundle of rays passing this part of the optical surface on which these projections or concavities are present, the specified optical influence is exerted on it, and as regards a bundle of rays passing the part of the optical surface where no projection or concavity is present, the specified optical influence is not exerted on it. For example, in the case where the projections or concavities have a polarizing function, it becomes possible to make one and the same bundle of rays independently have a plurality of optical characteristics locally in such a way that only for the portion of the bundle of rays passing the area of the optical surface of the optical element where the projections or concavities are present, by changing the state of polarization of it, the specified effect can be exhibited in a polarizing optical element provided at a later stage receiving the bundle of rays emerging out of the optical surface; however, for the portion of the bundle of rays passing the area of the optical surface of the optical element where no projection or concavity is present, the specified effect cannot be exhibited. In addition to this, by making the projections or concavities of the microscopic structure have a diffraction function and forming them partially on the optical surface of an optical element, it becomes possible that the principal bundle of rays passing the optical surface is used for image formation, while concurrently a part of the optical surface is used for the detection of the focus; this makes it possible to actualize the functions which have heretofore required two optical systems by means of an extremely simple, light-weight, and small-sized optical structure. Such an optical element can be molded by a metal die for molding an optical element of this invention.

A metal die for molding an optical element as set forth in the paragraph 10 is characterized by it that, in a part of the optical surface of said optical element, there are present projections or concavities having at least a plurality of shapes or arrangement patterns, and in a part of the aforesaid optical surface transfer surface, there are present corresponding concavities or projections having at least a plurality of shapes or arrangement patterns in order that the optical surface of said optical element may be formed by transfer.

For example, by forming projections or concavities of a microscopic structure to have a plurality of shapes or arrangement patterns on the optical surface of an optical element, and arranging them on said optical surface partially, it becomes possible to make this optical surface exhibit an optical function of the microscopic structure locally. By doing this, it becomes possible to make one and the same bundle of rays have a plurality of optical functions by exerting an optical influence, which is generated by the shapes or arrangement patterns of the projections or concavities of the microscopic structure, on the bundle of rays passing the optical surface partially or selectively. In this case, it is unnecessary that projections or concavities of a microscopic structure are always present on the whole surface of the optical surface of an optical element. That is, in cases where it has heretofore been necessary to combine a plurality of optical elements in order to exhibit the specified optical function, if an optical element which is molded by a metal die for molding an optical element of this invention is used, the optical element can exhibit the specified optical function by itself; therefore, the optical system can be more simplified and cost reduction by a large margin can be actualized. Further, by the use of a metal die for molding an optical element of this invention, such optical elements can be easily mass-produced.

A metal die for molding an optical element as set forth in the paragraph 11 has a composition of the aforesaid amorphous alloy containing palladium in a proportion of 20 mol % to 80 mol %; therefore, it is possible to suppress the oxidization of said amorphous alloy, which makes it possible to practice heat press working even in an atmospheric environment; this is convenient.

A metal die for molding an optical element as set forth in the paragraph 12 desirably has a composition of the aforesaid amorphous alloy containing any one of copper, nickel, aluminum, silicon, phosphorous, and boron in a proportion of at least 3 mol % or more.

A metal die for molding an optical element as set forth in the paragraph 13 is comprised of the aforesaid amorphous alloy deposited by a PVD (Physical Vapor Deposition) process; therefore, it is possible to accomplish a firm adhesion.

A metal die for molding an optical element as set forth in the paragraph 14 is comprised of the aforesaid amorphous alloy deposited by a sputtering process; therefore, it is possible to accomplish a firm adhesion.

A metal die for molding an optical element as set forth in the paragraph 15 is comprised of the aforesaid amorphous alloy deposited by an ion plating process; therefore, it is possible to accomplish a firm adhesion.

A metal die for molding an optical element as set forth in the paragraph 16 is comprised of the aforesaid amorphous alloy deposited by an evaporation coating process; therefore, it is possible to accomplish a firm adhesion.

A metal die for molding an optical element as set forth in the paragraph 17 is comprised of the aforesaid amorphous alloy deposited by a CVD (Chemical Vapor Deposition) process; therefore, it is possible to accomplish a firm adhesion.

A metal die for molding an optical element as set forth in the paragraph 18 is such one that, after the aforesaid amorphous alloy is deposited on the aforesaid base member, the aforesaid optical surface transfer surface is generated by heat press molding; therefore, by the utilization of the easy workability of said amorphous alloy in press molding, high-accuracy metal dies for molding an optical element can be produced in large quantities by a simple process.

A metal die for molding an optical element as set forth in the paragraph 19 is such one that, after the aforesaid amorphous alloy is deposited on the aforesaid base member, the aforesaid optical surface transfer surface is generated by diamond cutting; therefore, by the utilization of the good machinability of said amorphous alloy, high-accuracy metal dies for molding an optical element can be produced in large quantities by a simple process.

A metal die for molding an optical element as set forth in the paragraph 20 is such one that, after the aforesaid amorphous alloy is deposited on the aforesaid base member, the aforesaid optical surface transfer surface is generated by diamond cutting and heat press molding; therefore, by the utilization of the easy workability in press molding and good machinability of said amorphous alloy, high-accuracy metal dies for molding an optical element can be produced in large quantities by a simple process.

An optical element as set forth in the paragraph 21 is molded by means of a metal die for molding an optical element as set forth in the above-mentioned paragraphs; therefore, while it has a high accuracy, it can be produced at a low cost.

An optical element as set forth in the paragraph 22 is made of a plastic material, therefore, it can be easily produced at a low cost.

An optical element as set forth in the paragraph 23 is made of a glass material, therefore, it is excellent in aberration characteristic, etc.

An optical element as set forth in the paragraph 24 is desirably a lens for use in a optical pickup device for example.

The term “diffractive ring-shaped zones” means a diffractive surface which is made to have a function to converge or diverge a bundle of rays by diffraction by the relief being provided by the formation of approximately concentric circular ring-shaped zones centered on the optical axis on the optical surface of an optical element (a lens, for example). For example, it is known that, when a cross-section of it is viewed at a plane including the optical axis, each of the ring-shaped zones looks like a shape of a saw-tooth; the diffractive surface includes one having such a shape. Besides, in this specification, diffractive ring-shaped zones are also referred to as diffractive grooves.

In applying this invention, the shape of each unit of a microscopic structure and the array period of the units such as the way of arraying projections (or concavities) are of no concern. Whatever a microscopic structure it may be, as long as it is produced for the purpose of adding a new function to an optical element, the metal die for molding an optical element or an optical element produced by the metal die is included in the scope of this invention. Further, as regards the function to be added newly, it is not limited to such one as to reduce aberration. Also the case where aberration is intentionally increased in accordance with the characteristics of an optical system is included in the scope of this invention as long as it is done for the purpose of making the aberration come nearer to the ideal one finally.

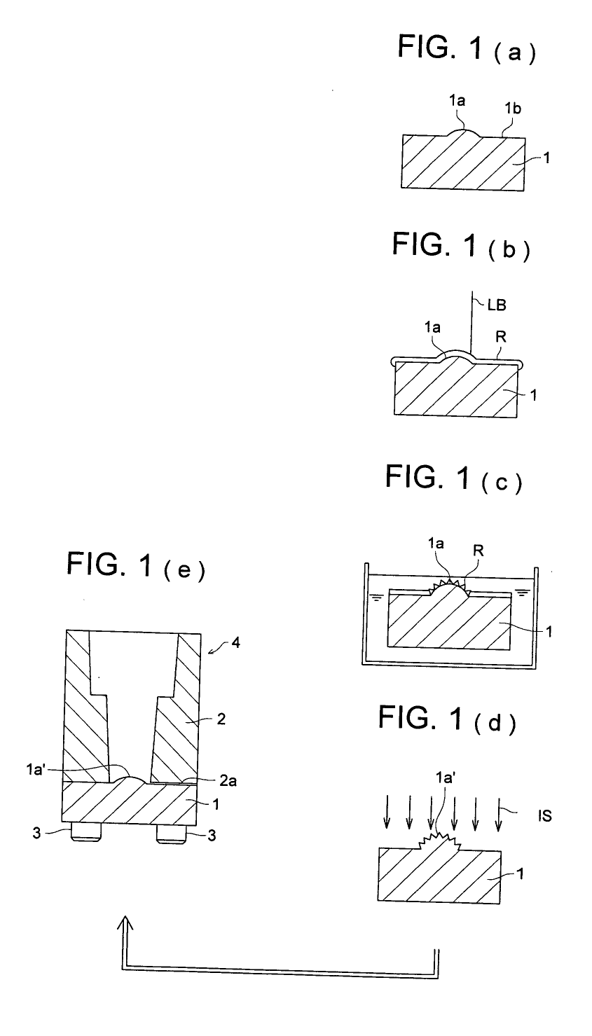

In the following, with reference to the drawings, the embodiment of this invention will be explained. FIG. 1 is a drawing showing a production process of a master die for producing a metal die for molding an optical element. First, as shown in FIG. 1(a), a generating optical surface 1a is formed on a master die base 1. This generating optical surface 1a agrees with the shape of the designed optical surface of a lens (an example of the optical element) which should be formed by the metal die for molding an optical element. Around the circumference of the generating optical surface 1a, it is formed a generating geometrical dimension reference surface 1b corresponding to the tilt reference plane.

Subsequently, as shown in FIG. 1(b), while the master die base 1 is being rotated around the optical axis by a driving member (not shown in the drawing), the generating optical surface 1a and the generating geometrical dimension reference surface 1b are coated with resist R (spin coating). The resist R is coated to a uniform thickness on the upper surface of the master die base 1 including the generating optical surface 1a and the generating geometrical dimension reference surface 1b.

Further, the generating optical surface 1a which has been coated with the resist R is irradiated by an electron beam LB from an exposure device (not shown in the drawing), to have a microscopic pattern formed by the exposure. Subsequently, as shown in FIG. 1(c), the master die base 1 is dipped in a solution, and the portion of the resist R corresponding to the microscopic pattern which has been formed by the exposure on the generating optical surface 1a is removed. In this process, because the beam diameter of the electron beam LB is extremely small, irradiation is made at intervals of several tens or several hundreds of nanometers; therefore, the resist R can be removed in accordance with that.

After that, as shown in FIG. 1(d), the upper surface of the master die base 1, from which the resist R has been partially removed, is exposed to an environment of an ion shower IS (accelerated argon ions etc.)(dry etching), and the surface layer of the master die base 1 corresponding to the pattern of the resist R is etched off. At this time, because the surface layer of the area where the resist R remains is not removed or difficult to remove, by leaving the microscopic circular portions of the resist R thick at the time of exposure, a large number of microscopic cylindrical projections are formed on the surface portions of the optical surface transfer surface 1a′ of the master die base 1 corresponding to those projections.

The master die base 1, having been formed in this way, is fixed with bolts 3 in such a way as to close the one end of a circular tube-shaped cylinder 2, to form a master die 4 (FIG. 1(e)). In order to form an air vent between the cylinder 2 and the master die base 1, a slot 2a is formed on the one end surface of the cylinder 2. In addition, large-scale equipment is required for the processing of the master die base 1, and its production cost is high; however, because one unit can mass-produce metal dies for molding an optical element as will be described later, there is no particular problem.

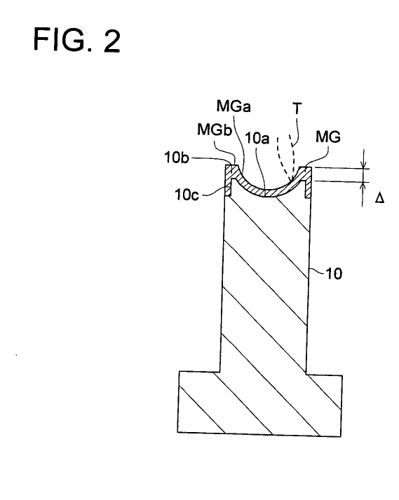

FIG. 2 is a drawing showing a production process of a metal die for molding an optical element. First, a base body 10 is formed of a stainless steel material or the like. The material of the base body 10 is not limited to a particular one, but it is desirably a metal die material which is generally used such as a steel or a stainless steel; if such a material is used, there is an advantage that the supply is stable and also the price is low. The base body 10 as a blank, having a concave portion 10a corresponding to the optical surface of an optical element (aspherical for example) and a peripheral surface portion 10b formed at its one end (the upper end in the drawing), comes to have an approximate shape of the metal die. The accuracy of shape of the concave portion 10a, the peripheral surface portion 10b, and an end circumferential surface 10c of the base body 10 depends on the film thickness of an amorphous alloy MG having a supercooled liquid region to be provided on the surface (hereinafter referred to as an amorphous alloy simply), and in the case where a film of the amorphous alloy MG having a thickness of an order of 100 μm, an accuracy within a range of 10 μm to 20 μm is sufficient; therefore, the working of the blank itself is such one that can be performed in several tens of minutes by the use of an NC lathe. On these concave portion 10a, peripheral surface portion 10b, and end circumferential surface 10c of the base body 10, the amorphous alloy MG having a supercooled liquid region is deposited in the following way.

A film of the amorphous alloy MG is formed on the surface of the concave portion 10a, the peripheral surface portion 10b, and the end circumferential surface 10c of the base body 10 by a PVD processing such as sputtering or evaporation coating, or a CVD processing. Besides, in this example of the embodiment, in addition to the concave portion 10a, the peripheral surface portion 10b and the end circumferential surface 10c are also filmed over with the amorphous alloy MG, but it is appropriate to film over the concave portion 10a only.

As regards the film forming of the amorphous alloy MG, CVD processing is not advantageous owing to the base body coming to have a high temperature, in view of the nature of the amorphous alloy to be brought in a supercooled liquid state; however, in this invention, film forming is not limited to either CVD processing or PVD processing. In PVD processing by which the amorphous alloy is comparatively easily formed to become a film, sputtering, ion plating, and evaporation coating are included, and in this invention, any one of them may be used. In this connection, in a sputtering method, the target material is not necessarily made to be in an amorphous state, and if the constituent atoms are deposited on the base body 10 in the desired composition ratio, because sputtering is accompanied by rapid cooling from its principle, a film is easily formed in an amorphous state. The speed of film formation is about 0.2 μm/h to several μm/h, and this can be easily shortened by raising the output power of the sputtering apparatus; however, the temperature of the base body 10 becomes high, which makes the film not amorphous, and cooling of the base body 10 by water for example becomes necessary. With too large a thickness of the film, the removal amount remains much in diamond cutting or heat press molding to be done after this processing, which lowers the efficiency; therefore, it is usually more desirable to make the thickness about 100 μm. Further, for the reason that a film thickness of several mm is required for a complex shape however, roughly speaking, a film thickness falling within a range of 10 nm to 1 mm is practical.

If the film thickness is especially large, by the amorphous alloy material jutting out over the portion other than the concave portion 10a, the peripheral surface portion 10b, and the end circumferential surface 10c of the base body 10, sometimes the design shape of the metal die for molding an optical element is damaged. For that reason, in some cases it is necessary to mask the portion other than the film formation area or to remove the jutting out portion by diamond cutting or grind-working; however, because the amorphous alloy has a good machinability and its removal amount is small, the load of the working labor time and the cost is little.

As described in this example of the embodiment, by using a small amount of amorphous alloy MG only in limited parts of a metal die for molding an optical element in this way, it has become possible to apply also such kind of amorphous alloy that is difficult to make a bulk shape with all its excellent characteristics in physical property, to a metal die for molding an optical element. For example, a high-hardness amorphous alloy containing nickel, copper, or others can be expected to have a high durability for a die material, but because it is hard to make it bulk-shaped, it is difficult to apply it to a metal die for molding an optical element by the method described in the prior applications; however, by making it a film as shown in this example of the embodiment, the application of it has become possible. Further, it sometimes occurred that, in bulk materials, a gas such as hydrogen was incorporated into the raw metal at the time of metallurgical processing to produce fine holes called “mold cavities”, and when it underwent diamond cutting or heat press molding, they appeared on the optical surface generated by the working, to produce surface defects; however, in the case where a film is formed from a vapor phase by a CVD processing or a PVD processing as this example of the embodiment, because “mold cavities” are hardly produced, the production yield of the metal die for molding an optical element can be maintained high, which makes it unnecessary to produce spare dies for coping with defective products for example; therefore, compared to the metal die for molding an optical element disclosed in the prior applications, the production cost is reduced by a large margin.

Subsequently, by applying diamond cut-working or heat press molding or a combination of these to the formed film of this amorphous alloy MG, the surface of the amorphous alloy MG is finished to become a desired optical surface transfer surface MGa and a geometrical dimension reference surface transfer surface MGb (corresponding to the peripheral surface portion 10b of the base body 10). Because diamond cutting is a process to cut-work articles one by one by a super-precision lathe (not shown in the drawing) or the like, with a single crystal diamond tool T shown by the dotted line in FIG. 2 used, the working article undergoes basically the same working process as a conventional method of producing a metal die based on nickel plating; however, compared to a conventional method, the optical surface transfer surface MGa and the geometrical dimension reference surface transfer surface MGb are formed rapidly and compactly by a PVD processing or a CVD processing, without being subjected to a chemical plating process; therefore, the following can be regarded as more excellent characteristics: that there is no defect such as a pin hole, that delivery time of processing is short, that the machinability is very good which makes the wear of tools less and the shape creation by cut-working easy, etc.

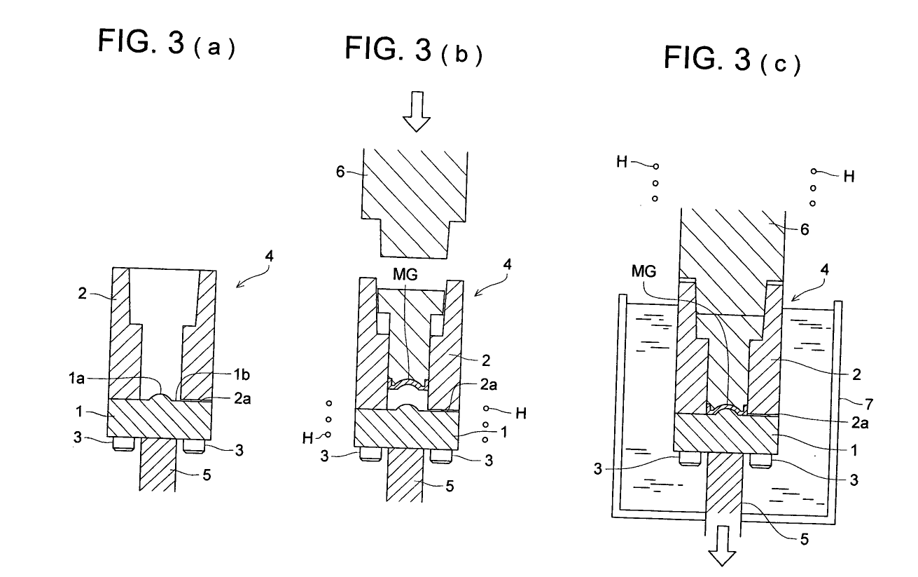

FIG. 3 is a drawing showing a process of forming an optical surface transfer surface and a geometrical dimension reference surface transfer surface of a metal die for molding an optical element by heat press molding. First, a support pole 5 is attached to the master die 4 which has been produced by a process shown in FIG. 1 as shown in FIG. 3(a). Subsequently, as shown in FIG. 3(b), after the preliminary heating of the surrounding portion of the generating optical surface 1a and the generating geometrical dimension reference surface 1b by a heater H disposed around the master die base 1, the base body 10 produced and the amorphous alloy film MG formed by a process shown in FIG. 2 (may be mechanically worked) are inserted into the cylinder 2, and pressed by a plunger 6. At this time, the air in the cylinder 2 flows out through the air vent (the slot 2a) to the outside. The heated amorphous alloy MG, having a flexibility like molten resin, is deformed to agree with the shape of the generating optical surface 1a and the generating geometrical dimension reference surface 1b of the master die base 1 even by a slight pressure application.

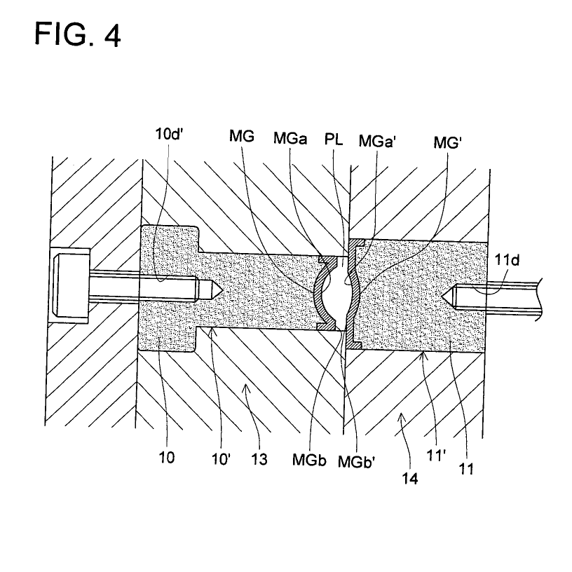

Further, as shown in FIG. 3(c), by making the master die 4 and the plunger 6 as a unified body sink in a container 7 filled with cooling water, the amorphous alloy MG is quenched. In addition, this cooling may be natural cooling. After that, by separating the master die 4 and the plunger 6, which have been taken out from the container 7, from each other, it becomes possible to take out a metal die for molding an optical element 10′ (FIG. 4) having the optical surface transfer surface MGa and the geometrical dimension reference surface transfer surface MGb respectively corresponding to the generating optical surface 1a and the generating geometrical dimension reference surface 1b formed on it. In the case where heat press molding is applied to a deep optical surface shape, a complex optical surface shape, or amorphous alloy to be easily oxidized, it is desirable to practice the processes of heating, molding, and cooling in vacuum.

FIG. 4 is a cross-sectional view of a die set containing a metal die for molding an optical element for forming a lens as an example of an optical element. The metal die for molding an optical element 10′ having a film of amorphous alloy MG formed on it in the above-mentioned way and the metal die for molding an optical element 11′ having a film of amorphous alloy MG′ formed on it in the same way are inserted into die-set metal dies 13 and 14 respectively, in such a way that the optical surface transfer surfaces MGa and MGa′ mutually face each other, and also the geometrical dimension reference surface transfer surfaces MGb and MGb′ mutually face each other, and molten plastic material PL is injected into the space between the metal dies for molding an optical element 10′ and 11′ from a gate (not shown in the drawing) in the same way as usual injection molding; further, by cooling it, a lens having the desired shape can be obtained. Besides, also in the case where screw holes 10d′ and 11d′ for fitting the die set are worked, in contrast with the amorphous alloy MG, only it is necessary to carry out the drilling and tapping in the base bodies 10 and 11 having an excellent toughness; therefore, breakage at the time of working can be suppressed, and breakage is suppressed also by it that the base bodies 10 and 11 have a function to relax the concentration of stress through bending against an external force at the time of molding.

In this example of the embodiment as described in the above, in the case where the optical surface transfer surface MGa or the geometrical dimension reference transfer surface MGb is generated, it is enough that the portion where a film of the amorphous alloy MG is formed is preponderantly heated to be softened, and is pressed to the heated master die 1. What is important is that, in this example of the embodiment, the amorphous alloy MG is not applied to the whole of the metal die for molding an optical element 10′, but it is limited to the layer for forming the optical surface transfer surface MGa and the geometrical dimension reference surface transfer surface MGb and the surrounding portion, and it is unnecessary to heat the whole base body 10 uniformly. Hence, compared to the case where heat press molding is applied to the whole bulk material of amorphous alloy, heating is easily done owing to the heat capacity being small, temperature control can be made in a high precision, and the deformation quantity by pressing is small too; therefore, the press time can be shortened by a large margin. These characteristics make the molding process easy to control, and on top of it, they make very good conditions for avoiding the crystallization of the amorphous alloy during heating; as the result of it, it is possible to do heat press molding over again even any number of times without paying attention to crystallization, which makes it possible to modify the shape of or to recycle the optical surface transfer surface MGa or the like without melting it down; further, it becomes possible to apply even a certain kind of amorphous alloy which has been unable to undergo heat press molding owing to it being easily crystallized with all its excellent characteristics in physical property to a metal die for molding an optical element.

To make the best of the characteristics of this invention to simplify the heating method further, after heating only the master die for molding an optical surface transfer surface or a geometrical dimension reference surface transfer surface on an amorphous alloy material to the molding temperature, a film of amorphous alloy formed on a base body is pressed to the master die, then, the amorphous alloy film is softened from the contact surface with the master die with the temperature becoming nearer to the molding temperature, and transfer forming proceeds; finally, when the whole surface of the amorphous alloy film is brought into close contact with the master die, the molding process is completed. In this way, because the pressing force is constant and molding is possible with almost no control, the generation working of the optical surface transfer surface or the geometrical dimension reference surface transfer surface of a metal die for molding an optical element can be done at a high accuracy and at a high efficiency by an extremely simple heat press molding apparatus. Further, when only the master die is heated, because the heat capacity becomes smaller, the temperature control can be made in a very high accuracy, which prevents the overheating due to the overshooting or hunting, and makes it possible to effectively prevent the crystallization or melting of the amorphous alloy during heat press molding.

As regards the environment for heat press molding, usually it is desirable to practice it in vacuum in order to prevent the oxidization of the amorphous alloy and crystallization based on the oxidization; however, palladium-contained amorphous alloys, owing to their being hardly oxidized even by heating in an atmospheric environment, can be subjected to heat press molding in an atmospheric environment. In this case, because it is unnecessary to maintain a vacuum environment, the heat press molding apparatus can be made simpler, and it has the advantage that heat press molding can be carried out as being visually observed directly in an atmospheric environment. For the palladium-contained amorphous alloy, Pd₄₀Cu₃₀Ni₁₀P₂₀, Pd₇₆Cu₆Si₁₈, Pd₆₁Pt₁₅Cu₆Si₁₈, etc. can be cited, and if palladium is not contained in an amount of at least 20 mol % or more, other constituent atoms become easy to oxidize or crystallize, which makes it difficult to carry out heat press molding in an atmospheric environment. On the other hand, in the case of palladium content of 80 mol % or more, generally speaking, no glass transition temperature exists and the alloy does not come to be in an amorphous state. For that reason, for an amorphous alloy material to undergo heat press molding stably in an atmospheric environment, it is desirable that the palladium content is not less than 20 mol % and less than 80 mol %. Further, it is necessary for making the alloy amorphous that it contains any one of copper, nickel, aluminum, silicon, phosphorous, and boron in an amount of at least 3 mol % or more. This can be said with regard to almost all kinds of amorphous alloys, not limited to palladium-contained amorphous alloys, such as Zr₅₅Al₁₀Cu₃₀Ni₅, Zr₅₇Ti₃Al₁₀Ni₁₀Cu₂₀, La₆₅Al₁₅Ni₂₀, La₅₅Al₁₅Ni₁₀Cu₂₀, Co₅₁Fe₂₁Zr₈B₂₀, Fe₅₆ Cu₇Ni₇Zr₁₀B₂₀, Mg₇₅Cu₁₅Y₁₀ and Mg₇₀Ni₂₀La₁₀. Further, in heat press molding in an atmospheric environment, if a closed space is produced between the master die and the molding surface of the amorphous alloy material, in some cases it becomes a stagnant air room to deteriorate the transferability of heat press molding. In these cases, it is appropriate to carry out heat press molding in vacuum even for an amorphous palladium-contained alloy. In a metal die for molding an optical element having a microscopic structure such as diffractive ring-shaped zones on its optical surface, microscopic stagnant air rooms tend to be produced especially in the microscopic structure portion, which damages the transferability remarkably; therefore, it is preferable to practice the heat press molding in vacuum.

In the case where an amorphous alloy material containing a noble metal such as palladium is used in a metal die for molding an optical element, if a bulk material is used, only one metal die has a high raw metal value; therefore, for handling such high-valued small parts in large quantities in the production line of optical elements, it is inevitable a problem on security such that safekeeping management should be done strictly. In a metal die for molding an optical element as described in this example of embodiment, however, because the film of the amorphous alloy can be made to have a thickness of an order of 100 μm, the value of the raw metal is only a fraction of one percent; therefore, it has a very important characteristic in practical use against the technology of the prior applications that its safekeeping management may be done as before.

As described up to now, a metal die for molding an optical element does not require a chemical plating process at all as is required for a conventional metal die, and is capable of generating an optical surface transfer surface at a high accuracy and at a high efficiency; hence, with all its capability of transfer molding of a high-accuracy optical element, it has an excellent characteristic that it is of a low cost, of a short delivery time, and able to be handled in a mode of production similar to a conventional one. Further, also a metal die for molding an optical element having a microscopic structure can be generated.

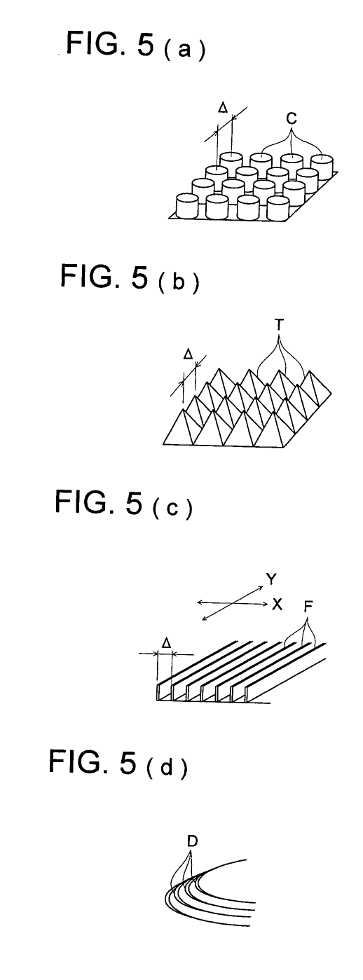

FIG. 5 are perspective views each showing enlarged the optical surface of a lens to be formed by such a metal die for molding an optical element. In FIG. 5(a), it is shown a structure such that a large number of microscopic cylinders C as an example of a plurality of projections are formed in a matrix arrangement (an example of a microscopic structure in an equivalent refractive index region). For example, in the case where this objective lens is used as an objective lens in an optical pickup device for DVD recording/reproduction, the light wave passing the lens has a wavelength of about 650 nm. Therefore, if the interval of the microscopic structure units Δ is made to be 160 nm, a light wave which is incident on this objective lens is scarcely reflected, and an objective lens having an extremely high light transmittance can be provided.

In FIG. 5(b), a large number of microscopic pyramids, which are formed separated by equal intervals Δ on the optical surface of a lens, are shown as an example of a plurality of projections, and they have a remarkable effect similar to the structure shown in FIG. 5(a). As regards this interval Δ, it is desirable to make it 0.1 to 0.2 μm because it reduces scattering. In FIG. 5(c), a large number of fins F, which are formed separated by intervals Δ on the optical surface of a lens, are shown as an example of a plurality of projections (an example of a microscopic structure of structural birefringence). The length of the fins is made longer than the wavelength of the transmitted light wave (650 nm or longer in the above-mentioned example). A lens provided with such a structure has an effect what is called a light polarizing effect that it transmits a light wave having the oscillation plane in the direction along the fins F but does not transmit a light wave having the oscillation plane in the direction crossing the fins F. In FIG. 5(d), diffractive ring-shaped zones D formed on the optical surface of a lens are shown as an example of continuous plural projections. Concerning the diffractive ring-shaped zones D, chromatic aberration correction and temperature correction which are effects due to the shape are described in detail in the publication of the unexamined patent application 2001-195769; therefore, further explanation of it will be omitted. Further, in FIG. 5(a) to FIG. 5(c), examples of projections being provided on a flat plane are shown for simplicity's sake; however, it is appropriate that the bottom surface is made a curved surface having a suitable curvature such as a spherical surface or an aspherical surface, and the projections are provided on the curved surface.

### EXAMPLE OF 1

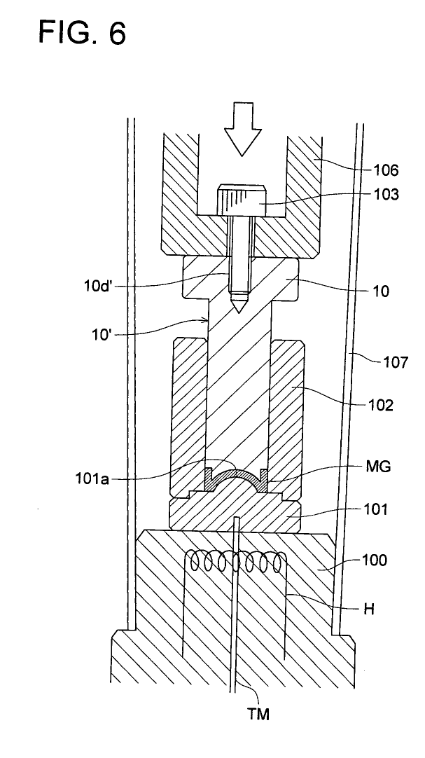

FIG. 6 is a cross-sectional view of a fixture for transferring a pattern which was used in a test practiced by the inventors of this invention. In FIG. 6, a heater H is provided buried in the inside of a base body 100 made of copper, and the end portion of a thermocouple TM penetrating the central portion of the base body 100 is provided buried in a master die 101 which is fixed at the upper surface of the base body 100. On the generating optical surface 101a of the master die 101, diffractive grooves (refer to FIG. 5(d)) having a sawtooth cross-sectional shape in a plane parallel to the optical axis are formed. Over the master die 101, a cylinder 102 is mounted, and a metal die for molding an optical element 10′, which has been produced by the process shown in FIG. 2, can be arranged in such a way as to be capable of sliding in the inside of it. By fitting a bolt 103 screwed into a tapped hole 10d′ formed at the upper end portion of the metal die for molding an optical element 10′, the metal die for molding an optical element 10′ is fixed at the lower end of a plunger 106. A quartz tube 107 is provided extending upward from the base body 100, and internal space of the tube is kept in a vacuum environment.

In practicing the test, as regards the metal die for molding an optical element 10′, an SUS304 stainless steel material was used for the base body 10. On the optical surface transfer surface of this, a film of amorphous alloy Pd₇₆Cu₆Si₁₈ is formed by sputtering to a thickness of 100 μm after 10 hours of processing. As regards the master die 101 for molding this, a silicon single crystal was spin-coated with a resist material to form two layers superposed to a thickness of 1.5 μm while being subjected to a baking processing. Further, by a method of pattern drawing using an electron beam, sawtooth-shaped grooves having steps with the height 0.8 μm are generated with the resist material through exposure to the electron beam with the dose quantity adjusted, and development. After that, while CF₄ gas is being introduced, plasma etching is carried out for 300 seconds, and sawtooth-shaped diffractive grooves having approximately the same shape with the selection ratio 1:1 were transferred onto the silicon single crystal. After that, by the use of the pattern transfer fixture shown in FIG. 6, the master die 101 and the amorphous alloy MG of the metal die for molding an optical element 10′ were heated to 340° C. in vacuum (heated by the heater H and the temperature was measured by the thermocouple TM), and molding was carried out with a pressing force of 30 N applied. After kept under pressing for five minutes, it was cooled to the room temperature. The cooling was carried out by introducing the atmosphere at the room temperature into the quartz tube 107. The total molding time including the heating time was 15 minutes. When measured, the transferred shape of the optical surface transfer surface of the molded metal die for molding an optical element was found to be such one that the amount of the step was 0.78 μm and the surface roughness of the tilt surface was 200 nmPV; thus, sawtooth-shaped diffractive grooves enough to practical use were obtained.

### EXAMPLE OF 2

As regards an objective lens for an optical pickup device for interchangeable use of a DVD and a CD, the optical design was optimized in such a way that the aspherical optical surface facing towards the light source was divided into two parts, the inner zone and the outer zone, and in order that a bundle of rays passing the whole optical surface might be used for the writing and reproducing of a DVD, and a bundle of rays passing the inner zone might be used for the writing and reproducing of a CD, each spherical aberration was adjusted. In this design, on the inner zone of the optical surface, which was the common use area for a DVD and a CD, cone-shaped projections having a height of 300 nm were arranged at equal intervals of 150 nm for reducing the reflectance at the light source wavelength 650 nm for a CD and at the light source wavelength 780 nm for a DVD. Further, on the outer zone of the optical surface, which was to be used only for a DVD, in order that a chromatic aberration might not be produced by the influence of the wavelength shift of the semiconductor laser of the light source, it was made an optical design in which blaze-type primary diffractive grooves having the step height 1.3 μm were arranged. For a master die for producing a metal die for molding an objective lens, a bulk material of quartz was used, it was worked to have a shape of a convex aspherical optical surface by a super-precision grind-working, and the surface was coated with a resist material to a thickness of 1.5 μm by spin coating. After this was processed by baking, it was subjected to the exposure writing of a microscopic structure pattern by a three-dimensional pattern drawing apparatus using an electron beam, development, and rinse, to have a cone-shaped moth eye pattern for reducing reflection on the inner zone, and a blaze-type diffractive groove pattern for chromatic aberration correction on the outer zone, formed with the resist material on the aspherical optical surface of the master die. Further, by introducing a fluoride gas to carry out plasma etching, a microscopic structure the same as the resist was formed transferred on the bulk substrate of quartz with the selection ratio 1:1. As regards the metal die for molding an optical element, a pre-hardened steel material CENA1, which is a steel material of adjusted quality for a metal die made by Hitachi Metal Co., Ltd., was used for the base body, the outer shape was finished by a versatile-use NC lathe, and an optical surface transfer surface having a concave shape was generated in an accuracy of shape of 1.5 μm. The working time was about 30 minutes per unit including the arrangement time. Further, for the metal die for molding an optical element to become in a coaxial arrangement with the master die in heat press molding, a cylindrical-shaped drum-type fixture was produced. Further, on the optical surface transfer surface of the metal die for molding an optical element, a film of a palladium-contained amorphous alloy Pd₄₀Cu₃₀Ni₁₀P₂₀ was formed to a thickness of 100 μm. The master die was fixed under the drum-type fixture, the metal die for molding an optical element was inserted into the drum-type fixture from the upper side, both aspherical optical surfaces are made to face each other, and a load of 120 kg was applied to the bottom of the metal die for molding an optical element. The master die was heated to 360° C. by the heater and left as it was; by carrying out heat press molding, the amorphous alloy became softened to be in compliance with the master die in 15 minutes, and both optical surfaces became in close contact with each other. After that, heating by the heater was stopped, and after the master die was cooled by being left as it was, the metal die for molding an optical element was taken out. The optical surface transfer surface of the metal die for molding an optical element had the concave optical surface shape of the generating aspherical surface transferred on it, and onto the inner zone of it cone-shaped holes for molding moth eye pattern for reducing reflection were transferred, and further, blaze-type groove pattern for correcting chromatic aberration was transferred onto the outer zone of it. Because the optical surface transfer surface of the metal die for molding an optical element, however, first began to engage with the central portion of the master die, no stagnant air room was formed on the molding surface transfer surface, but moth eye pattern in a central area of the optical surface having a diameter of 0.5 mm was damaged. The overall transfer performance of the microscopic structure was very good. When plastic objective lenses were produced by the use of this metal die for molding an optical element, it was found that the reflectance of the inner zone was not so much different between the wavelength 650 nm and wavelength 780 nm, and the difference was about 0.2%, which is equivalent to the reflection reducing coating by a multi-layer film. Further, as regards the shift of the light source wavelength at the time of reproduction, particularly, even in the case of writing where a mode hop phenomenon of a semiconductor laser occurs with the output of the semiconductor laser becoming larger, there was no fluctuation of the focus position, and a satisfactory eye pattern and jitter characteristic with no writing error were shown.

By this invention, it is possible to provide a metal die for molding an optical element which is of low cost and excellent in the ease of handling, nevertheless, is excellent in machinability, and while its dimensional precision is capable of being enhanced, is capable of molding a high-function optical element having a microscopic structure in a transmission refractive index region, a microscopic structure exhibiting a reflection reducing effect, a microscopic structure producing structural birefringence, a microscopic structure in a resonance region, a function to correct an aberration change such as the change of chromatic aberration due to the fluctuation of the light source wavelength, a function to correct the aberration change due to temperature variation, projections or concavities to be regarded as a super-microscopic structure provided with diffractive ring-shaped zones or the like, simply at a high accuracy, and at a low cost, and an optical element molded by the metal die.

What is claimed is:

1. A optical element forming die, comprising:
a die base body; and
an optical surface transferring layer to form an optical surface of the optical element, the optical surface transferring layer formed by depositing an amorphous alloy having a supercooled liquid region on the die base body, wherein a plurality of projections or concavities are provided on the optical surface transferring layer so that a plurality of concavities or projections corresponding to the plurality of projections or concavities on the optical surface transferring layer are transferred and formed on the optical surface of the optical element.

2. The optical element forming die of claim 1, wherein the plurality of concavities or projections of the optical surface of the optical element is formed in a microscopic structure having an equivalent refractive index region.

3. The optical element forming die of claim 1, wherein the plurality of concavities or projections of the optical surface of the optical element is formed in a microscopic structure having a reflection preventing effect.

4. The optical element forming die of claim 1, wherein the plurality of concavities or projections of the optical surface of the optical element is formed in a microscopic structure generating a structural birefringence.

5. The optical element forming die of claim 1, wherein the plurality of concavities or projections of the optical surface of the optical element is formed in a microscopic structure having a resonance region.

6. The optical element forming die of claim 1, wherein the plurality of concavities or projections of the optical surface of the optical element has a function to correct variations in aberration due to variations in wavelength of a light source to irradiate the optical element with a light flux.

7. The optical element forming die of claim 1, wherein the plurality of concavities or projections of the optical surface of the optical element has a function to correct variations in aberration due to variations in temperature of the optical element.

8. The optical element forming die of claim 1, wherein the plurality of concavities or projections of the optical surface of the optical element are diffractive ring-shape zones.

9. The optical element forming die of claim 1, wherein a plurality of projections or concavities are provided on a part of the optical surface transferring layer so that a plurality of concavities or projections corresponding to the plurality of projections or concavities on the optical surface transferring layer are transferred and formed on a part of the optical surface of the optical element.

10. The optical element forming die of claim 1, wherein a plurality of projections or concavities having plural shapes or plural arrangements patterns are provided on a part of the optical surface transferring layer so that a plurality of concavities or projections having plural shapes or plural arrangements patterns corresponding to the plurality of projections or concavities on the optical surface transferring layer are transferred and formed on a part of the optical surface of the optical element.

11. The optical element forming die of claim 1, wherein the amorphous alloy has a composition containing palladium in a proportion of 20 mol % to 80 mol %.

12. The optical element forming die of claim 1, wherein the amorphous alloy has a composition containing any one of copper, nickel, aluminum, silicon, phosphorous, and boron in a proportion of at least 3 mol % or more.

13. The optical element forming die of claim 1, wherein the amorphous alloy is deposited on the die base body by a PVD process.

14. The optical element forming die of claim 13, wherein the amorphous alloy is deposited on the die base body by a spattering process.

15. The optical element forming die of claim 13, wherein the amorphous alloy is deposited on the die base body by an ion-plating process.

16. The optical element forming die of claim 13, wherein the amorphous alloy is deposited on the die base body by a vapor deposition process.

17. The optical element forming die of claim 1, wherein the amorphous alloy is deposited on the die base body by a CVD process.

18. The optical element forming die of claim 1, wherein after the amorphous alloy is deposited on the die base body so as to form an amorphous alloy layer on the base body, the amorphous alloy layer is shaped to be the optical surface transferring layer including the plurality of projections or concavities by a heat pressing process.

19. The optical element forming die of claim 1, wherein after the amorphous alloy is deposited on the die base body so as to form an amorphous alloy layer on the base body, the amorphous alloy layer is shaped to be the optical surface transferring layer including the plurality of projections or concavities by a cutting process with a diamond cutting tool.

20. The optical element forming die of claim 1, wherein after the amorphous alloy is deposited on the die base body so as to form an amorphous alloy layer on the base body, the amorphous alloy layer is shaped to be the optical surface transferring layer including the plurality of projections or concavities by a heat pressing process and a cutting process with a diamond cutting tool.

21. An optical element produced by using the optical element forming die described in claim 1.

22. The optical element of claim 21, wherein the optical element is made of a plastic material.

23. The optical element of claim 21, wherein the optical element is made of a glass material.

24. The optical element of claim 21, wherein the optical element is a lens.
